(19) United States
(12) Patent Application Publication
(10) Pub. No.: US 2012/0197904 A1
(43) Pub. Date: Aug. 2, 2012

(54) SYSTEMS AND METHODS FOR DOMINANCE RANKINGS

(76) Inventor: Kishen Iyengar, Boulder, CO (US)

(21) Appl. No.: 13/019,188

(22) Filed: Feb. 1, 2011

(51) Int. Cl. G06F 17/30

(52) U.S. Cl. 707/748; 707/E17.044

(57) ABSTRACT

This disclosure describes systems and methods for dominance rankings. The disclosure describes a novel approach for determining dominance rankings between competing interacting objects.

A research journal's perceived quality plays a large role in the number of readers the journal receives and influences the number and quality of authors who attempt to publish in the journal. Further, authors who publish in more prestigious journals are more likely to obtain promotions and tenure. Articles published in high quality journals are more likely to be influential and/or cited in other works. Even if an article does not become recognized in a field, articles published in high quality journals will at least experience a temporary period of citation from the journal's perceived quality. Accordingly, assessing journal quality and the quality of the journal ranking system are extremely important to the research community, since institutions, editors, authors, and researchers have a vested interest in the accuracy of these rankings.

### SUMMARY

This disclosure describes systems and methods for dominance rankings. The disclosure describes a novel approach for determining dominance rankings between competing interacting objects.

In part, this disclosure describes a method for dominance ranking competing interacting objects. The method includes performing the following steps:

a) selecting a group of interacting competing objects for ranking;

b) constructing an asymmetric matrix of agnostic interactions between the objects of the group;

c) constructing a dominance matrix by comparing all pairs of objects and assigning a value of at least one of 1.0, 0.5, and 0.0 to a corresponding cell in the dominance matrix;

d) calculating a number of circular triads with an equation as follows:

$$d = \frac{n ( n - 1 ) ( 2 n - 1 )}{12} - \frac{{Σ ( {S}_{i} )}^{2}}{2} ;$$

e) calculating a dominance coefficient for each of the objects, wherein the dominance coefficient is based on at least one of Landau's coefficient of hierarchy and Kendall's coefficient of consistency; and

f) ranking the objects based at least on the calculated dominance coefficient for each object.

Yet another aspect of this disclosure describes a dominance ranking system for dominance raking competing interacting objects that includes: at least one processor; and at least one memory, communicatively coupled to the at least one processor and containing instructions that, when executed by the at least one processor, perform a method comprising:
a) selecting a group of interacting competing objects for ranking;
b) constructing an asymmetric matrix of agnostic interactions between the objects of the group;
c) constructing a dominance matrix by comparing all pairs of objects and assigning a value of at least one of 1.0, 0.5, and 0.0 to a corresponding cell in the dominance matrix;
d) calculating a number of circular triads with an equation as follows:

$$d = \frac{n ( n - 1 ) ( 2 n - 1 )}{12} - \frac{{Σ ( {S}_{i} )}^{2}}{2} ;$$

f) calculating a dominance coefficient for each of the objects, wherein the dominance coefficient is based on at least one of Landau's coefficient of hierarchy and Kendall's coefficient of consistency; and
g) ranking the objects based at least on the calculated dominance coefficient for each object.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. The benefits and features of the technology will be realized and attained by the structure particularly pointed out in the written description and claims hereof as well as the appended drawings.

It is to be understood that both the foregoing general description and the following detailed description are exemplary and explanatory and are intended to provide further explanation of the technology as claimed.

### BRIEF DESCRIPTION OF THE DRAWINGS

The following drawing figures, which form a part of this application, are illustrative of embodiments systems and methods described below and are not meant to limit the scope of the technology in any manner, which scope shall be based on the claims appended hereto.

FIG. 1 illustrates an embodiment of a method for dominance ranking interacting objects.

FIG. 2 illustrates an embodiment of a method for determining if calculated dominance coefficients have a linear hierarchy.

FIG. 3 illustrates an embodiment of a method for ranking objects with equivalent dominance coefficients.

FIG. 5 illustrates an embodiment of a method for normalizing object interactions during construction of an asymmetric matrix of agnostic interactions when the number of interactions per object varies.

FIG. 6 illustrates an embodiment of line graph showing trends in journal ranking over 2008, 2007, and 2006.

### DETAILED DESCRIPTION

Although the systems and methods introduced above and discussed in detail below may be utilized in a variety of ways, the present disclosure will discuss the utilization of these systems and methods for the ranking of interacting objects in some type of competition with each other, such as journals and sports teams. The reader will understand that the technology described in the context of journals and/or sports teams could be adapted for use with other interacting objects in competition with each other, such as journal articles, sport team players, and coaches. This list is not meant to be limiting and is merely exemplary.

As discussed above, ranking assumes a particularly important activity in academia. Many important decisions in academia, including tenure and funding, depend on journal rankings. Ranking impacts the resources and stature of institutions as well as the academic faculty members who work in such institutions. However, there is a considerable amount of variation in how different institution value different journals.

In spite of its importance, or perhaps due to it, ranking journals has been a controversial exercise. While some institutions and published studies resort to a subjective assessment of journals in according them importance, others rely on bibliometric evaluation. For example, many studies have used subjective ratings to assign ranks to journals. Such studies are based on survey responses sent out to faculty. These subjective assessments of journal rankings suffer some serious shortcomings, such as regional and technology area biases. The ISI impact factors by Thomson Scientific are often used as an objective measure of journal quality. The impact factor for any journal is calculated as the count of citations in a year to papers publicized in the journal during the past two years divided by the number of articles published in the two years. The impact factor has many shortcomings including, the inclusion of self-citations and the short length of time considered.

Articles based on such objective measure still introduce their own biases. Even when multiple indices are calculated and then averaged to assigned ranks, they only succeed in spreading the variance on the different dimensions of the journals in consideration. Furthermore, even minor non-significant differences on the value of the indices are enough for a journal to be ranked above another. The assumption that all these studies implicitly make is that there is indeed a journal hierarchy of ranking, which is captured by the indices that are computed.

Accordingly, the systems and methods disclosed herein for ranking journals are desirable because they provide a method for determining whether a hierarchy exists amongst the journals and can account for journal self citations. Further, the disclosed systems and methods are desirable because they provide a method for determining whether the hierarchy observed is statistically significant or due to chance.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

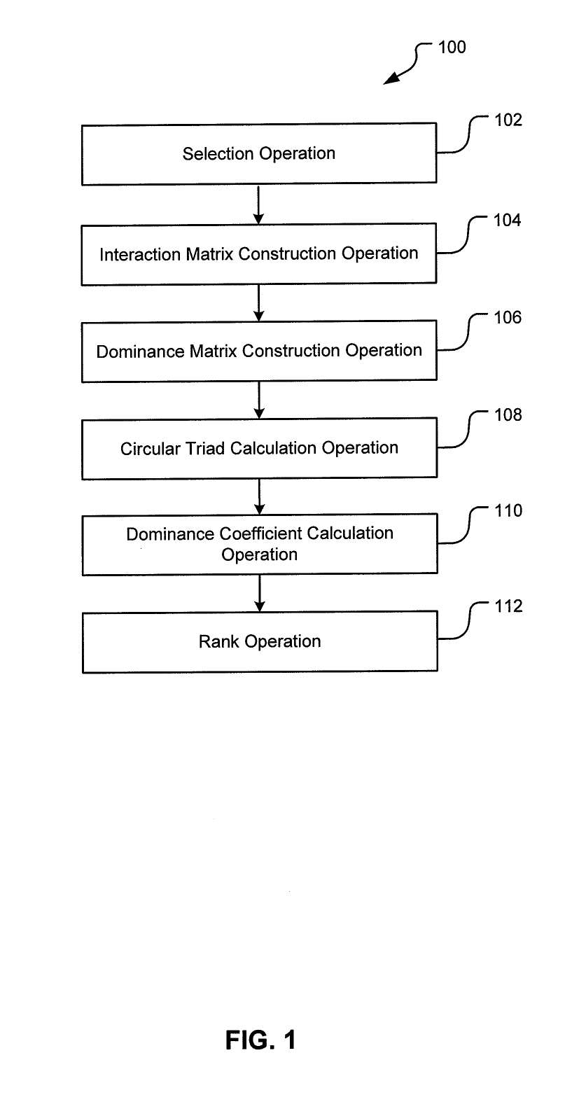

FIG. 1 represents an embodiment of a method 100 for dominance ranking interacting objects in some type of competition with each other. As illustrated, method 100 includes a selection operation 102. In the selection operation 102, a dominance ranking system selects a group of competing interacting objects for ranking. In one embodiment, the interacting objects include journals, journal articles, sport teams, sport team players, or coaches. This list is not meant to be limiting and is exemplary only. The dominance ranking system may be any individual, plurality of individuals, processor, plurality of processors, computer system, plurality of computer systems, any combination of individuals and processing systems, etc.

Next, method 100 includes an interaction matrix construction operation 104. In the interaction matrix construction operation 104, the dominance ranking system constructs an asymmetric matrix of agnostic interactions between the objects of the group. The matrix is constructed by lining up each object as a heading on two axes of the matrix in the same order. The interactions are then counted between the objects as they line up on the matrix. The interactions may include wins, touchdowns, citations, goals, goals given up, and etc. This list is exemplary only and is not meant to be limiting. Further, interactions between the object itself, such as self citations (see Table 3 below of Example 2), are listed in the diagonal row of this matrix. Accordingly, this method of ranking accounts for self citations. If there are no interactions between the object itself, then the diagonal row is left blank (see Table 1 below of Example 1). It is understood by a person skill in the art that the interactions counted may be any suitable interactions between objects in the selected group for constructing the asymmetric matrix of agnostic interactions. For example, Table 1 listed below in Example 1 illustrates an asymmetric matrix of wins between cricket teams in direct competition with each other.

The dominance ranking system in the interaction matrix construction operation 104 performs a method 400 for normalizing the objects interactions as illustrated in FIG. 4 during the construction of the asymmetric matrix of agnostic interactions. Method 400 includes a determination operation 402. In determination operation 402, the dominance ranking system determines if the number of interactions between objects varies.

If the number of interactions between objects varies, then the dominance ranking system performs a normalization operation 404. In the normalization operation, the dominance ranking system divides each interaction calculation in the asymmetric matrix of agnostic interactions by the total number possible interactions for that object. For example, if the interactions are wins for an object, then each win calculation for an object is divided the total number games played by that that object. Accordingly, in this scenario the interactions listed in the asymmetric matrix of agnostic interactions are in proportions, as illustrated in Example 2 in Table 4 below. Once the normalization operation 404 of method 400 has been performed, the dominance ranking system performs a dominance matrix construction operation 106 of method 100. If the number of interactions between objects does not vary, then the dominance ranking system performs the dominance matrix construction operation 106 of method 100.

Further, method 100 includes a dominance matrix construction operation 106. In the dominance matrix construction operation 106, the dominance ranking system constructs a dominance matrix by comparing all pairs of objects and assigning a value of at least one of 1.0, 0.5, and 0.0 to the corresponding cell in the dominance matrix. The structure of the dominance matrix is identical to the asymmetric matrix of agnostic interactions. The comparing of all pairs of objects includes comparing the interaction values between objects. For example, in Table 1 below Australia has beaten England 58 times and England has beaten Australia only 37 times. After the comparison, a value is assigned in the dominance matrix. If the value of 1.0 is assigned in the dominance matrix to the team with the most interactions between two objects, then a value of zero is assigned in the dominance matrix to the least number of interactions between two objects (i.e. England 1.0 and Australia 0.0). If the value of 1.0 is assigned in the dominance matrix to the team with the least interactions between two objects, then a value of zero is assigned in the dominance matrix to the most number of interactions between two objects (i.e. England 0.0 and Australia 1.0). In some embodiment, the number interactions between a pair of two objects are tied. In the instances of a tie, in some embodiments, a value of zero or 1.0, which ever represents the least number of interactions, is assigned in the dominance matrix to the tie (i.e. Object A 0.0 and Object B 0.0). In alternative embodiments, in the instance of a tie, a value of 0.5 is assigned in the dominance matrix (i.e. Object A 0.5 and Object B 0.5). Table 2 and Table 5 from examples 1 and 2 below illustrate two different examples of a dominance matrix.

In an additional embodiment, when the interactions have been normalized and are listed in proportions, the dominance matrix construction operation 106 may utilize a two-sample test for proportions (i.e. a Z-test for two proportions) to assign the values to the pairs of objects. In this embodiment, a value of 1.0 is assigned to one object and a value of zero is assigned to the other object only if a significant difference exists between the two objects based on the result of the two-sample test for proportions. If the two-sample test for proportions result shows that the difference between the two objects is not significant, then the same value representing a tie, as described above, is assigned to both objects (i.e. 0.5, 1.0, or 0.0). For example, consider the comparison of ISR and MISQ from table 4 in Example 2 described below. The proportions are 0.0469 for ISR and 0.0424 for MISQ. These proportions are not significantly different based on the two-sample test for proportions with a 90% confidence level. Accordingly, in this embodiment, these objects would be considered tied and assigned the appropriate value to represent a tie in the dominance matrix. For example, ISR and MISQ could both be assigned a value of 0.5 to represent the tie. When appropriate, the two-sample test for proportions may be utilized when comparing any two objects during method 100 to ensure that any differences are statistically significant.

Next, method 100 includes a circular triad calculation operation 108. In the circular triad calculation operation 108, the dominance ranking system calculates the number of circular triads with the following equation:

$$d = \frac{n ( n - 1 ) ( 2 n - 1 )}{12} - \frac{{Σ ( {S}_{i} )}^{2}}{2} .$$

The meaning of each variable is listed below:

d=the number of circular triads;

n=the number of objects in the group; and

i=1 to n;

Sᵢ=row totals in the dominance matrix (i.e. the number of objects dominated by an object)

The greater the number of circular triads, the greater is the inconsistency in interactions between the objects. If there are no circular triads, then the interactions are consistent with a hierarchical structure.

Method 100 also includes a dominance coefficient calculation operation 110. The dominance ranking system in the dominance coefficient calculation operation 110 calculates a dominance coefficient for each of the objects. The dominance coefficient is based on Landau's coefficient of hierarchy and/or Kendall's coefficient of consistency.

Landau's coefficient is calculated utilizing the following equation:

$$h = \frac{12}{( {n}_{3} - n )} {\sum }_{i = 1}^{n} {[ {V}_{i} - ( n - 1 ) / 2 ]}^{2} .$$

The meaning of the variables is in this equation is listed below:
h=Landau's coefficient;
n=the number of objects in the group;
i=1 to n; and
Vᵢ=the number of individuals dominated by object i.

The maximum number of circular triads is (n³−n)/24 if n is odd and (n³−4n)/24 if n is even (where n equals the total number of objects in the group). Accordingly, if the total number of objects in the group is odd (i.e. n=odd number), then Kendall's coefficient is calculated utilizing the following equation:

$$K = 1 - \frac{24 d}{( {n}_{3} - n )} ;$$

and
Further, if the total number of objects in the group is even (i.e. n=even number), then Kendall's coefficient is calculated utilizing the following equation:

$$K = 1 - \frac{24 d}{( {n}_{3} - 4 n )} .$$

The meanings of the variables in these equations are listed below:
K=Kendall's coefficient;
n=the number of objects in the group; and
d=the number of circular triads.
   However, if all the of the dominance relationships are ties, then Kendall's coefficient becomes negative due to the assumption of strict dominance between all interactions, which the equations for calculating Kendall's coefficient are based on. Accordingly, in one embodiment, if some of the dominance relationships are ties, it is better to use Landau's coefficient.

Next, method 100 includes rank operation 112. The dominance ranking system in the rank operation 112 ranks each object based at least on the dominance coefficients. Objects with higher dominance coefficients are ranked above objects with lower dominance coefficients.

In some instances, objects have equivalent dominance coefficients. In some embodiment, the equivalent dominance coefficients are ranked as ties. In alternative embodiments, the equivalent dominance coefficients are ranked.

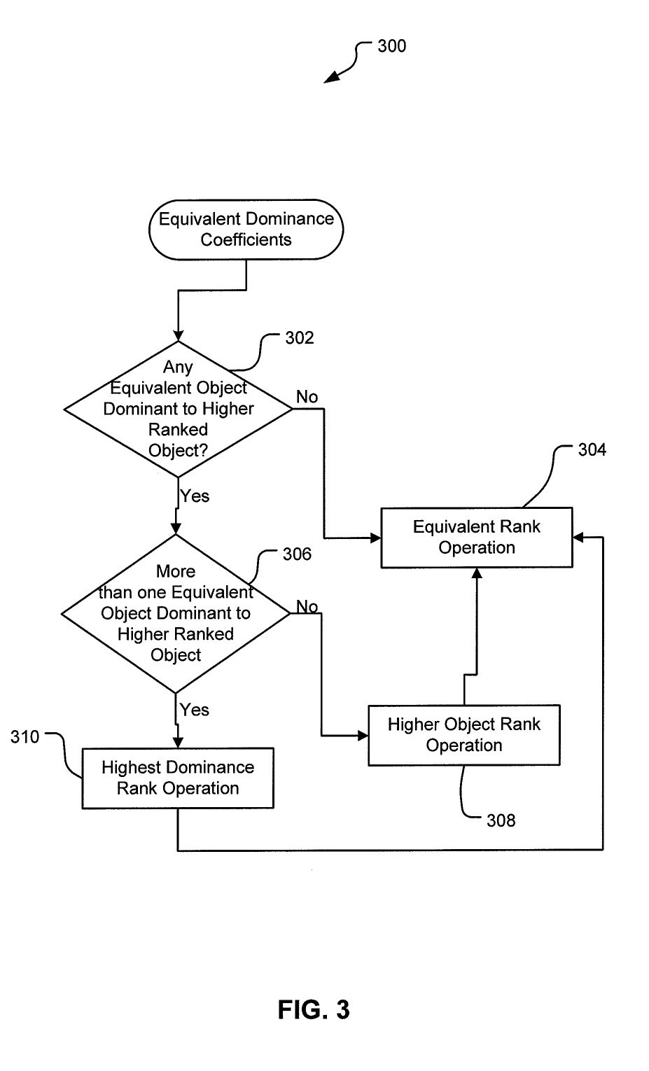

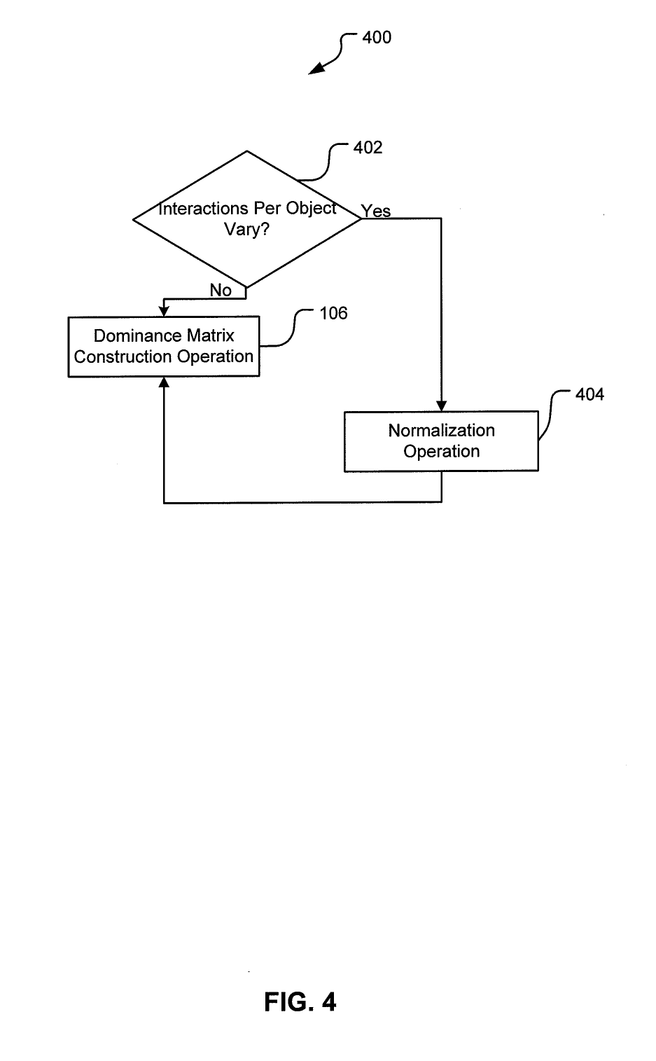

An embodiment of a method 300 for ranking equivalent dominance coefficients is shown in FIG. 3 and may be utilized in method 100. As illustrated, method 300 includes a higher ranked determination operation 302. In the higher ranked determination operation 302, the dominance ranking system determines if any of the equivalent objects are dominant to a higher ranked object based on at least one of the interactions listed in the asymmetric matrix of agnostic interactions and the assigned value in the dominance matrix.

If none of the objects are dominant to a higher ranked object, then the dominance ranking system performs equivalent rank operation 304. In the equivalent rank operation 304, the dominance ranking system ranks the equivalent objects based on which object has the highest number of interactions listed between the objects in the asymmetric matrix of agnostic interactions or has the highest assigned value in the dominance matrix between the objects. For example, as illustrated in Example 1 below, England and New Zealand have equivalent dominance coefficients; however, New Zealand has more wins over England than England has over New Zealand. Accordingly, New Zealand is ranked above England in Example 2 below when utilizing method 300. If the interactions between the objects are equivalent, then the dominance ranking system in equivalent rank operation 304 ranks the objects that are the most dominant to the highest lower ranked objects above the remaining lower ranked objects.

If any of the objects with the equivalent dominance coefficients are dominant to a higher ranked object, then the dominance ranking system performs a multiple higher rank determination operation 306 of method 300. In the multiple higher rank determination operation 306, the dominance ranking system determines if more than one object with the equivalent dominance coefficients is dominant to a higher ranked object.

If only one object is dominant to a higher ranked object, then the dominance ranking system performs a higher object rank operation 308 of method 300. In the higher object rank operation 308, the dominance ranking system ranks the object dominant to a higher ranking object above the remaining objects with equivalent dominance coefficients. The remaining objects with equivalent coefficients are ranked according to equivalent rank operation 304.

If a plurality of objects with equivalent dominance coefficients are dominant to a higher ranked object, then the dominance ranking system performs a highest dominance rank operation 310 of method 300. In the highest dominance rank operation 310, the dominance ranking system ranks these objects in order of the highest dominance over the highest ranking object. For example, if two teams New Zealand and England have equivalent dominance coefficients, but New Zealand is dominant to the highest rank team of Australia and England is dominant to the second highest rank team of South Africa, then New Zealand is ranked above England because New Zealand dominates the highest rank team. In another example, if two teams New Zealand and England have equivalent dominance coefficients and both are dominant to the same higher ranked team of South Africa, then the team with most wins against South Africa is ranked the highest. Any remaining objects with equivalent coefficients are ranked according to the equivalent rank operation 304.

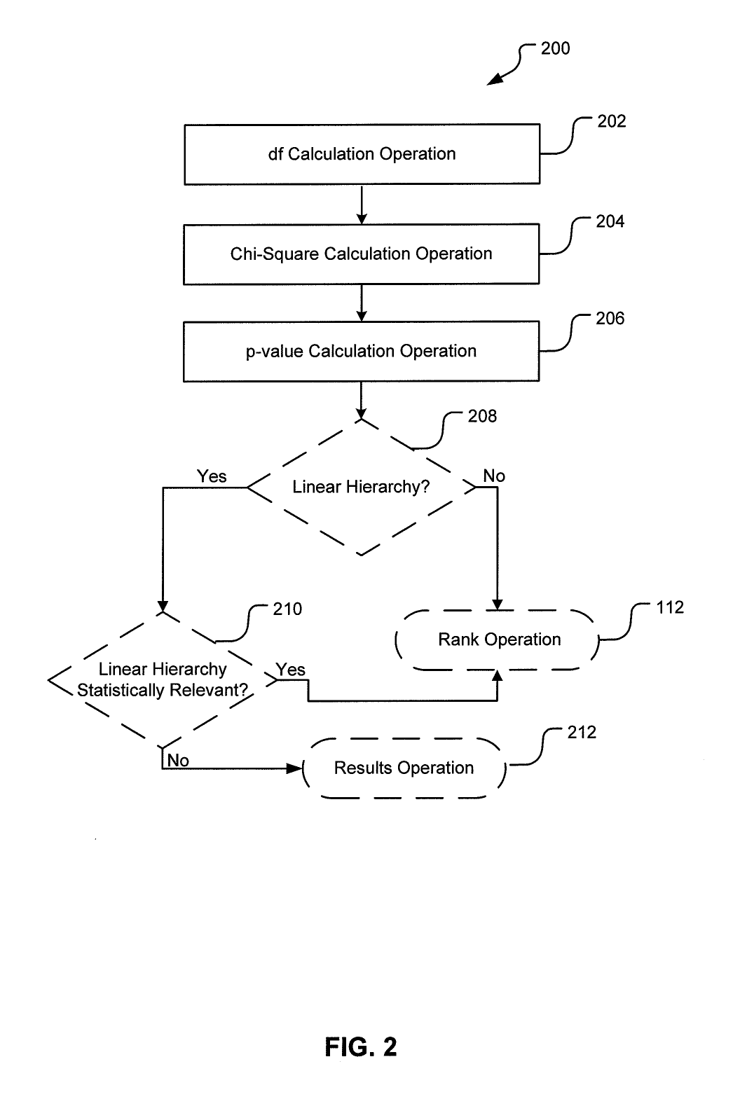

In some embodiments, method 100 further includes a method 200 for determining if a linear hierarchy exists amongst the objects as illustrated in FIG. 2.

In some embodiments, method 100 further includes a degrees of freedom calculation operation 202. In one embodiment, the degrees of freedom calculation operation 202 is part of method 200 as illustrated in FIG. 2. In the degrees of freedom calculation operation 202, the dominance ranking system calculates the degrees of freedom for the dominance coefficients. The degrees of freedom is calculated utilizing the following equation:

$$df = \frac{n ( n - 1 ) ( n - 2 )}{{( n - 4 )}^{2}}$$

In further embodiments, method 100 further includes a chi-square calculation operation 204. In one embodiment, the chi-square calculation operation 204 is part of method 200 as illustrated in FIG. 2. In the chi-square calculation operation 204, the dominance ranking system calculates the chi-square distribution for the dominance coefficients when the total number objects in the group is six or greater. The chi-square distribution is calculated utilizing the following equation:

$${X}^{2} = \frac{8}{n - 4} [ \frac{n ( n - 1 ) ( n - 2 )}{24} - d + 1 / 2 ] + df$$

In some embodiments, method 100 further includes a p-value calculation operation 206. In one embodiment, the p-value operation 206 is part of method 200 as illustrated in FIG. 2. In the p-value calculation operation 206, the dominance ranking system calculates the p-value for the dominance coefficients. The p-value is calculated utilizing know methods.

In further embodiments, method 100 includes a linear hierarchy determination operation 208. In one embodiment, the linear hierarchy determination operation 208 is part of method 200 as illustrated in FIG. 2. The dominance ranking system in the linear hierarchy determination operation 208, determines if the interacting objects have a linear hierarchy structure based on the chi-square test statistic, the degrees of freedom, and/or the p-value calculations. If there is a linear hierarchy structure, then the dominance ranking system performs the rank operation 112. If there is no linear hierarchy and the hierarchy created by the rank operation 112 is merely due to chance, then the dominance ranking system performs results operation 212 of method 200. In results operation 212, the dominance ranking system disregards any order created by the rank operation 112 as being inaccurate and/or not statistically significant.

As discussed above the dominance ranking system may be any individual, plurality of individuals, processor, plurality of processors, a computer system, plurality of computer systems, any combination of individuals and processing systems, etc.

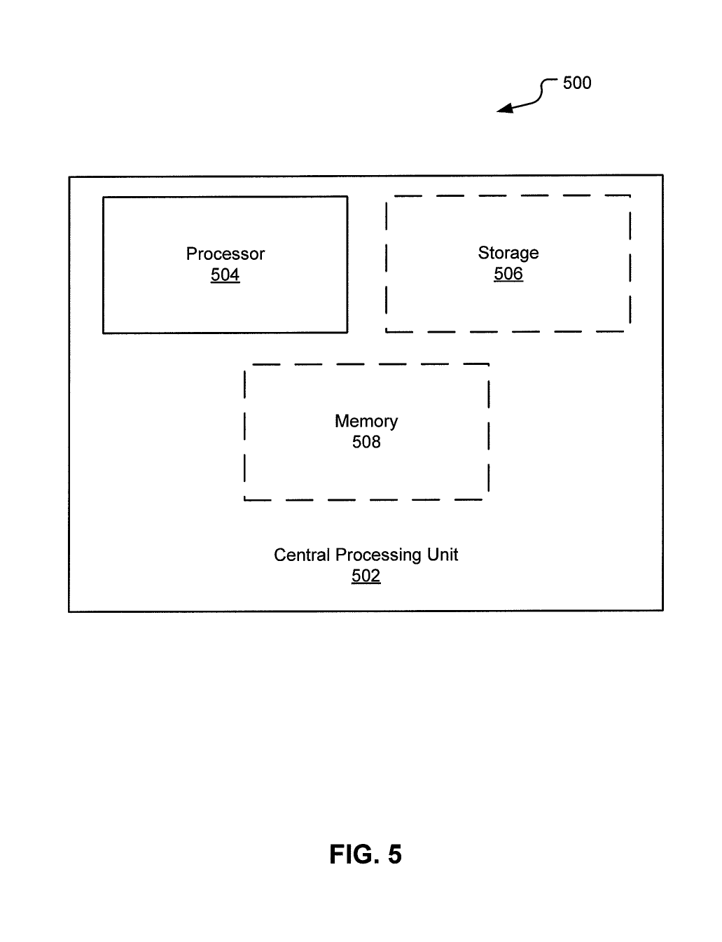

FIG. 5 illustrates an embodiment of a dominance ranking system 500. The dominance ranking system 500 includes a central processing unit (CPU) 502. The CPU 502 includes one or more processors 504, memory 506, storage 508, and/or other components of the type commonly found in command and control computing devices.

The memory 506 is non-transitory or transitory computer-readable storage media that stores software that is executed by the processor and which controls the operation of the dominance ranking system 500. In an embodiment, the memory 506 comprises one or more solid-state storage devices such as flash memory chips. In an alternative embodiment, the memory 506 may be mass storage connected to the processor through a mass storage controller (not shown) and a communications bus (not shown). Although the description of non-transitory computer-readable media contained herein refers to a solid-state storage, it should be appreciated by those skilled in the art that non-transitory computer-readable storage media can be any available media that can be accessed by the processor. Non-transitory computer-readable storage media includes volatile and non-volatile, removable and non-removable media implemented in any method or technology for storage of information such as computer-readable instructions, data structures, program modules or other data. Non-transitory computer-readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the processor.

The at least one memory 508 is communicatively coupled to the at least one processor 504. The processor 504 contains instructions that, when executed by the at least one processor 504, perform the method 100 discussed above and illustrated in FIGS. 1-4.

### EXAMPLES

### Example 1

In order to illustrate the systems and methods described above, data pertaining to the sport cricket, in particular, one-day internationals (ODI's) was utilized. The data was gathered from the ESPN-Cricinfo website (http://stats.cricinfo.com/ci/content/records/283885.html) and is provided below in an asymmetric matrix of agnostic interactions in Table 1. Over the last three decades, these international teams have played each other several times. The rows represent the winning team, and the columns represent the opposition in Table 1. For example, among all matches that have been played between England and Australia, Australia has won 58 matches, whereas England has won 37. From this table, a dominance matrix was constructed. The dominance matrix is shown below in Table 2.

TABLE 1
One-day International's data from Cricinfo.com

| | Australia | England | India | Pakistan | Sri Lanka | West Indies | New Zealand | South Africa |
|---|---|---|---|---|---|---|---|---|
| Australia | — | 58 | 57 | 46 | 46 | 58 | 80 | 39 |
| England | 37 | — | 30 | 35 | 22 | 37 | 29 | 15 |
| India | 32 | 38 | — | 45 | 60 | 37 | 40 | 20 |
| Pakistan | 29 | 26 | 68 | — | 70 | 47 | 47 | 16 |
| Sri Lanka | 20 | 21 | 43 | 45 | — | 18 | 31 | 21 |
| West Indies | 57 | 41 | 54 | 64 | 26 | — | 24 | 12 |
| New Zealand | 32 | 34 | 36 | 29 | 34 | 20 | — | 17 |
| South Africa | 35 | 22 | 35 | 35 | 22 | 32 | 29 | — |

TABLE 2
Dominance Matrix

| | | | | | Sri | West | New | South | Row Total | Dominance |
|---|---|---|---|---|---|---|---|---|---|---|
| | Australia | England | India | Pakistan | Lanka | Indies | Zealand | Africa | (Vᵢ) | Coefficient |
| Australia | | 1 | 1 | 1 | 1 | 1 | 1 | 1 | 7 | 12.25 |
| England | 0 | | 0 | 1 | 1 | 0 | 0 | 0 | 2 | 2.25 |
| India | 0 | 1 | | 0 | 1 | 0 | 1 | 0 | 3 | 0.25 |
| Pakistan | 0 | 0 | 1 | | 1 | 0 | 1 | 0 | 3 | 0.25 |
| Sri Lanka | 0 | 0 | 0 | 0 | | 0 | 0 | 0 | 0 | 0 |
| West Indies | 0 | 1 | 1 | 1 | 1 | | 1 | 0 | 5 | 2.25 |
| New Zealand | 0 | 1 | 0 | 0 | 1 | 0 | | 0 | 2 | 2.25 |
| South Africa | 0 | 1 | 1 | 1 | 1 | 1 | 1 | | 6 | 6.25 |
| Total | | | | | | | | | | 38 |

For the dominance matrix in Table 2, the number of circular triads was calculated to be d=2. Further, Kendall's coefficient of consistence K and Landau's index of hierarchy h both have a value of about 0.905. The degrees of freedom (df) and χ² are calculated to be 46 and 21 respectively. The p-value for this statistic was 0.0012. Thus, fair evidence of linear hierarchical structure was demonstrated in this example. There are two pairs that have a tied ranking. India and Pakistan are tied for fourth and England and New Zealand are tied for sixth. Pakistan receives a higher rank than India, as does New Zealand over England based on the comparison of their assigned dominance values. (i.e. Pakistan 1 vs. India 0; New Zealand 1 vs. England 0) Accordingly the rank order for this example is Australia, South Africa, West Indies, Pakistan, India, New Zealand, England and Sri Lanka.

### Example 2

Twelve journals that are well-known in the IS field were selected for dominance ranking. For each of these journals, data for the year 2008 on how many times each of the other journals were cited was collected from the Journal Citation Reports. The raw data is given below in an asymmetric matrix of agnostic interactions in Table 3. The rows represent the journal citations, whereas column headings indicate the cited journal. Thus, among all citations published in ISR in the year 2008, 77 were MISQ articles. On the other hand, among all citations in MISQ, 123 were articles published in ISR. Diagonals represent journal self-citations.

TABLE 3
2008 Journal Co-citation Matrix

| | | | | | | | | | | | | | Total No. of |
|---|---|---|---|---|---|---|---|---|---|---|---|---|---|
| | MISQ | ISR | JMIS | CACM | EJIS | DSS | IM | JAIS | JSIS | JIT | JASIST | ISM | References |
| MISQ | 244 | 123 | 52 | 72 | 19 | 15 | 47 | 6 | 4 | 16 | 7 | 14 | 2899 |
| ISR | 77 | 65 | 24 | 31 | 2 | 2 | 4 | 2 | 0 | 3 | 7 | 0 | 1643 |
| JMIS | 134 | 101 | 174 | 52 | 6 | 18 | 26 | 11 | 15 | 13 | 4 | 2 | 2407 |
| CACM | 17 | 14 | 5 | 116 | 3 | 3 | 5 | 0 | 0 | 5 | 7 | 4 | 1663 |
| EJIS | 214 | 118 | 88 | 59 | 136 | 21 | 88 | 17 | 13 | 26 | 2 | 7 | 3164 |
| DSS | 164 | 72 | 65 | 109 | 5 | 326 | 42 | 8 | 7 | 14 | 46 | 7 | 4905 |
| IM | 167 | 67 | 75 | 33 | 11 | 16 | 225 | 3 | 17 | 9 | 4 | 3 | 2006 |
| JAIS | 207 | 83 | 77 | 69 | 21 | 22 | 31 | 38 | 12 | 18 | 4 | 4 | 1911 |
| JSIS | 70 | 29 | 15 | 23 | 16 | 7 | 9 | 3 | 37 | 3 | 0 | 2 | 1056 |
| JIT | 79 | 24 | 15 | 35 | 16 | 0 | 18 | 4 | 4 | 29 | 0 | 6 | 1516 |
| JASIST | 61 | 43 | 27 | 81 | 4 | 15 | 28 | 11 | 3 | 4 | 595 | 0 | 7870 |
| ISM | 35 | 17 | 31 | 30 | 3 | 7 | 14 | 2 | 3 | 4 | 3 | 20 | 992 |

Since there is variation in the number of citations allowed per article in various journals, the proportion of references was calculated by dividing each number by the total references for the journal (i.e. normalized). This data is shown below in an asymmetric matrix of agnostic interactions in Table 4. Thus, while 5.57% of all citations appearing in JMIS cited MISQ articles, only 1.79% of all citations in MISQ cited JMIS.

TABLE 4
2008 Journal Co-citation Proportion Matrix

| | MISQ | ISR | JMIS | CACM | EJIS | DSS | IM | JAIS | JSIS | JIT | JASIST | ISM |
|---|---|---|---|---|---|---|---|---|---|---|---|---|
| MISQ | 0.0842 | 0.0424 | 0.0179 | 0.0248 | 0.0066 | 0.0052 | 0.0162 | 0.0021 | 0.0014 | 0.0055 | 0.0024 | 0.0048 |
| ISR | 0.0469 | 0.0396 | 0.0146 | 0.0189 | 0.0012 | 0.0012 | 0.0024 | 0.0012 | 0.0000 | 0.0018 | 0.0043 | 0.0000 |
| JMIS | 0.0557 | 0.0420 | 0.0723 | 0.0216 | 0.0025 | 0.0075 | 0.0108 | 0.0046 | 0.0062 | 0.0054 | 0.0017 | 0.0008 |
| CACM | 0.0102 | 0.0084 | 0.0030 | 0.0698 | 0.0018 | 0.0018 | 0.0030 | 0.0000 | 0.0000 | 0.0030 | 0.0042 | 0.0024 |
| EJIS | 0.0676 | 0.0373 | 0.0278 | 0.0186 | 0.0430 | 0.0066 | 0.0278 | 0.0054 | 0.0041 | 0.0082 | 0.0006 | 0.0022 |
| DSS | 0.0334 | 0.0147 | 0.0133 | 0.0222 | 0.0010 | 0.0665 | 0.0086 | 0.0016 | 0.0014 | 0.0029 | 0.0094 | 0.0014 |
| IM | 0.0833 | 0.0334 | 0.0374 | 0.0165 | 0.0055 | 0.0080 | 0.1122 | 0.0015 | 0.0085 | 0.0045 | 0.0020 | 0.0015 |
| JAIS | 0.1083 | 0.0434 | 0.0403 | 0.0361 | 0.0110 | 0.0115 | 0.0162 | 0.0199 | 0.0063 | 0.0094 | 0.0021 | 0.0021 |
| JSIS | 0.0663 | 0.0275 | 0.0142 | 0.0218 | 0.0152 | 0.0066 | 0.0085 | 0.0028 | 0.0350 | 0.0028 | 0.0000 | 0.0019 |
| JIT | 0.0521 | 0.0158 | 0.0099 | 0.0231 | 0.0106 | 0.0000 | 0.0119 | 0.0026 | 0.0026 | 0.0191 | 0.0000 | 0.0040 |
| JASIST | 0.0078 | 0.0055 | 0.0034 | 0.0103 | 0.0005 | 0.0019 | 0.0036 | 0.0014 | 0.0004 | 0.0005 | 0.0756 | 0.0000 |
| ISM | 0.0353 | 0.0171 | 0.0313 | 0.0302 | 0.0030 | 0.0071 | 0.0141 | 0.0020 | 0.0030 | 0.0040 | 0.0030 | 0.0202 |

From the asymmetric matrix of agnostic interactions shown in Table 4, the dominance matrix shown below in Table 5 was derived. It may be noted that while an assigned dominance of 1 in a cell that this object dominates the other object, in our situation, this is reversed. Thus, the cell corresponding to JMIS(row) and MISQ (column) has a value of 1, indicating that a greater proportion of JMIS references cited MISQ, rather than the other way around. Thus MISQ “dominates” JMIS.

TABLE 5
2008 Journal Co-citation Dominance Matrix

| | | | | | | | | | | | | | Row Total | Dominance |
|---|---|---|---|---|---|---|---|---|---|---|---|---|---|---|
| | MISQ | ISR | JMIS | CACM | EJIS | DSS | IM | JAIS | JSIS | JIT | JASIST | ISM | (Vᵢ) | Coefficient |
| MISQ | | 0 | 0 | 1 | 0 | 0 | 0 | 0 | 0 | 0 | 0 | 0 | 1 | 20.25 |
| ISR | 1 | | 0 | 1 | 0 | 0 | 0 | 0 | 0 | 0 | 0 | 0 | 2 | 12.25 |
| JMIS | 1 | 1 | | 1 | 0 | 0 | 0 | 0 | 0 | 0 | 0 | 0 | 3 | 6.25 |
| CACM | 0 | 0 | 0 | | 0 | 0 | 0 | 0 | 0 | 0 | 0 | 0 | 0 | 30.25 |
| EJIS | 1 | 1 | 1 | 1 | | 1 | 1 | 0 | 0 | 0 | 1 | 0 | 7 | 2.25 |
| DSS | 1 | 1 | 1 | 1 | 0 | | 1 | 0 | 0 | 1 | 1 | 0 | 7 | 2.25 |
| IM | 1 | 1 | 1 | 1 | 0 | 0 | | 0 | 0 | 0 | 0 | 0 | 4 | 2.25 |
| JAIS | 1 | 1 | 1 | 1 | 1 | 1 | 1 | | 1 | 1 | 1 | 1 | 11 | 30.25 |
| JSIS | 1 | 1 | 1 | 1 | 1 | 1 | 1 | 0 | | 1 | 0 | 0 | 8 | 6.25 |
| JIT | 1 | 1 | 1 | 1 | 1 | 0 | 1 | 0 | 0 | | 0 | 0 | 6 | 0.25 |
| JASIST | 1 | 1 | 1 | 1 | 0 | 0 | 1 | 0 | 1 | 1 | | 0 | 7 | 2.25 |
| ISM | 1 | 1 | 1 | 1 | 1 | 1 | 1 | 0 | 1 | 1 | 1 | | 10 | 20.25 |
| Total | | | | | | | | | | | | | | 135 |

The dominance matrix shown in Table 4 illustrates four circular triads that if “>” stands for the phrase “is cited more by” are as follows:

1. DSS>EJIS>JIT; however JIT>DSS

2. DSS>JSIS>JASIST; however JASIST>DSS

3. EJIS>JIT>JASIST; however JASIST>EJIS

4. EJIS>JSIS>JASIST; however JASIST>EJIS

Landau's h was calculated to be 0.944. The degrees of freedom (df) and χ² are 20.625 and 72.125 respectively. The p-value is almost zero. These results indicate that there is a linear hierarchy between the journals under consideration. Once a linear structure is established, the rankings for each of the journals may be established. The ranking of the twelve journals is shown below in Table 6.

TABLE 6
2008 Journal
Ranking

| | Row | |
|---|---|---|
| Journal | Sum | Rank |
| CACM | 0 | 1 |
| MISQ | 1 | 2 |
| ISR | 2 | 3 |
| JMIS | 3 | 4 |
| IM | 4 | 5 |
| JIT | 6 | 6 |
| JASIST | 7 | 7 |
| DSS | 7 | 8 |
| EJIS | 7 | 9 |
| JSIS | 8 | 10 |
| ISM | 10 | 11 |
| JAIS | 11 | 12 |

Data was collected for the years 2007 and 2006 and a dominance ranking analysis was performed. The χ² values are 55 and 61 for 2007 and 2006 respectively. This indicates evidence of a linear hierarchy within the journals. The journals and their ranking for 2007 and 2006 are shown below in Table 7.

TABLE 7
2007 and 2006 Rankings

| Journal | Rank for 2007 | Rank for 2006 |
|---|---|---|
| CACM | 3 | 1 |
| DSS | 10 | 9 |
| EJIS | 7 | 6 |
| IM | 5 | 5 |
| ISM | 11 | 8 |
| ISR | 2 | 3 |
| JASIST | 6 | 7 |
| JIT | 9 | 11 |
| JMIS | 4 | 4 |
| JSIS | 8 | 10 |
| MISQ | 1 | 2 |

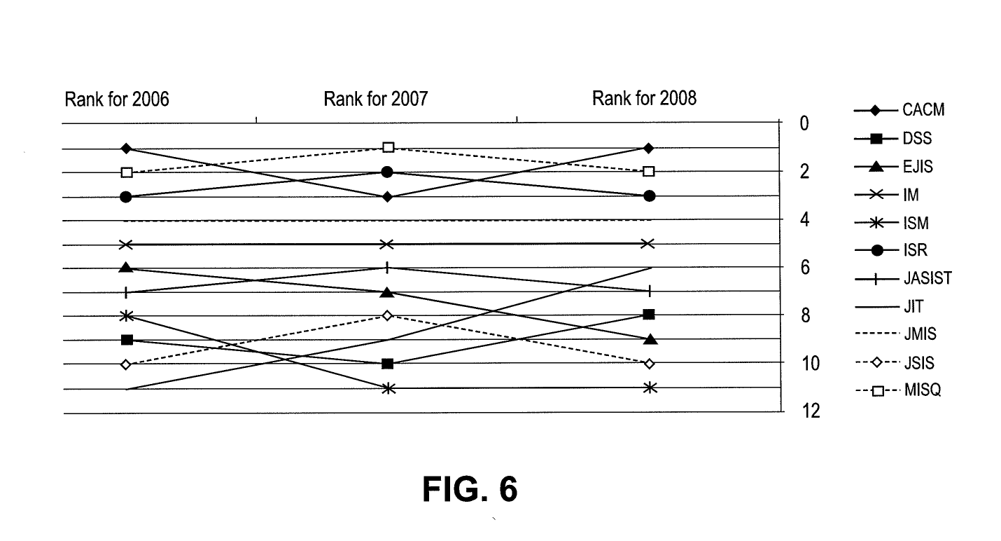

FIG. 6 illustrates a line chart with the trend in rankings for each journal across the three years evaluated in this example. The x axis represents time, and the y axis represents journal ranking. Top ranked journals are higher in the chart, and lower ranked journals are at the bottom of the chart.

### Example 3

Further, a similar analysis of data that considers only those cited articles that were published in the last five years, 2004 through 2008 for the journals analyzed above was also conducted. That is, the number of articles appearing in journal A over the last 5 years, cited by journal B in 2008. The proportions were again calculated and used to normalize the results. The dominance matrix is given below in Table 8.

TABLE 8
2008 Journal Co-citation Last 5 years Dominance Matrix

| | | | | | | | | | | | | | Row Total | Dominance |
|---|---|---|---|---|---|---|---|---|---|---|---|---|---|---|
| | MISQ | ISR | JMIS | CACM | EJIS | DSS | IM | JAIS | JSIS | JIT | JASIST | ISM | (Vᵢ) | Coefficient |
| MISQ | | 0 | 0 | 0 | 0 | 0 | 0 | 0 | 0 | 0 | 0 | 0 | 0 | 30.25 |
| ISR | 1 | | 0 | 1 | 0 | 0 | 0 | 0 | 0 | 0 | 0 | 0 | 2 | 12.25 |
| JMIS | 1 | 1 | | 1 | 0 | 1 | 0 | 0 | 0 | 1 | 1 | 0 | 6 | 0.25 |
| CACM | 1 | 0 | 0 | | 0 | 0 | 0 | 0 | 0 | 0 | 0 | 0 | 1 | 20.25 |
| EJIS | 1 | 1 | 1 | 1 | | 1 | 1 | 1 | 0 | 0 | 1 | 0 | 8 | 6.25 |
| DSS | 1 | 1 | 0 | 1 | 0 | | 0 | 0 | 0 | 1 | 1 | 0 | 5 | 0.25 |
| IM | 1 | 1 | 1 | 1 | 0 | 1 | | 0 | 0 | 0 | 1 | 0 | 6 | 0.25 |
| JAIS | 1 | 1 | 1 | 1 | 0 | 1 | 1 | | 0 | 1 | 1 | 0 | 8 | 6.25 |
| JSIS | 1 | 1 | 1 | 1 | 1 | 1 | 1 | 1 | | 1 | 0.5 | 1 | 10.5 | 25 |
| JIT | 1 | 1 | 0 | 1 | 1 | 0 | 1 | 0 | 0 | | 0 | 1 | 6 | 0.25 |
| JASIST | 1 | 1 | 0 | 1 | 0 | 0 | 0 | 0 | 0.5 | 1 | | 0.5 | 5 | 0.25 |
| ISM | 1 | 1 | 1 | 1 | 1 | 1 | 1 | 1 | 0 | 0 | 0.5 | | 8.5 | 9 |
| | | | | | | | | | | | | | | 110.5 |

The analysis of the dominance matrix provides evidence for linearity in the hierarchy. Landau's h value was 0.773. The p-value was still close to zero, with degrees of freedom, 20.625 and χ² value 59.875. There are three sets of ties. These ties are broken by using the pair wise comparisons as described above in method 300. The rankings are given below in Table 9.

TABLE 9
Journal Ranking for 5
Years and all years

| | | All year |
|---|---|---|
| Journal | Rank 5 year | Rank |
| CACM | 2 | 1 |
| DSS | 5 | 8 |
| EJIS | 10 | 9 |
| IM | 8 | 5 |
| ISM | 11 | 11 |
| ISR | 3 | 3 |
| JAIS | 9 | 12 |
| JASIST | 4 | 7 |
| JIT | 6 | 6 |
| JMIS | 7 | 4 |
| JSIS | 12 | 10 |
| MISQ | 1 | 2 |

Numerous other changes may be made which will readily suggest themselves to those skilled in the art and which are encompassed in the spirit of the disclosure and as defined in the appended claims. While various embodiments have been described for purposes of this disclosure, various changes and modifications may be made which are well within the scope of the present disclosure. Numerous changes may be made which will readily suggest themselves to those skilled in the art and which are encompassed in the spirit of the disclosure and as defined in the appended claims.

What is claimed is:

1. A method for dominance ranking competing interacting objects, comprising:
selecting a group of interacting competing objects for ranking;
constructing an asymmetric matrix of agnostic interactions between the objects of the group;
constructing a dominance matrix by comparing all pairs of objects and assigning a value of at least one of 1.0, 0.5, and 0.0 to a corresponding cell in the dominance matrix;
calculating a number of circular triads with an equation as follows:
$$d = \frac{n ( n - 1 ) ( 2 n - 1 )}{12} - \frac{{Σ ( {S}_{i} )}^{2}}{2} ;$$
calculating a dominance coefficient for each of the objects, wherein the dominance coefficient is based on at least one of Landau's coefficient of hierarchy and Kendall's coefficient of consistency; and
ranking the objects based at least on the calculated dominance coefficient for each object.

2. The method of claim 1, wherein the step of calculating the Landau's coefficient, comprises utilizing an equation as follows:
$$h = \frac{12}{( {n}_{3} - n )} {\sum }_{i = 1}^{n} {[ {V}_{i} - ( n - 1 ) / 2 ]}^{2} .$$

3. The method of claim 1, wherein the step of calculating the Kendall's coefficient, comprises:
utilizing an equation if a total number of the objects in the group is odd as follows:
$$K = 1 - \frac{24 d}{( {n}_{3} - n )} ;$$
and
utilizing an equation if the total number of the objects in the group is even as follows:
$$K = 1 - \frac{24 d}{( {n}_{3} - 4 n )} .$$

4. The method of claim 1, further comprising:
calculating degrees of freedom;
calculating a chi-square test statistic; and
calculating a p-value,
wherein a total number of the objects is six or larger.

5. The method of claim 4, further comprising:
determining if the objects have a linear hierarchy structure based at least one of the chi-square test statistic, the degrees of free, and the p-value.

6. The method of claim 5, further comprising:
determining if the linear hierarchy structure is statistically relevant based on at least one of the chi-square test statistic, the degrees of free, and the p-value.

7. The method claim 1, where the step of constructing the asymmetric matrix of agnostic interactions comprises:
determining that interactions per object vary; and
normalizing the interactions per object.

8. The method of claim 1, wherein the ranking step further comprises:
determining that at least some of the dominance coefficients are equivalent; and
ranking the objects with the equivalent dominance coefficients based on the interactions listed in the asymmetric matrix of agnostic interactions and the assigned values in the dominance matrix between the objects with the equivalent dominance coefficients.

9. The method of claim 8, wherein the ranking step further comprises:
determining that none of the objects with the equivalent dominance coefficients are dominant to a higher ranked object based on at least one of the interactions listed in the asymmetric matrix of agnostic interactions and the assigned value listed in the dominance matrix between the objects with the equivalent dominance coefficients before performing the step of ranking the objects with the equivalent dominance coefficients.

10. The method of claim 1, wherein the ranking step further comprises:
determining that at least some of the dominance coefficients are equivalent;
determining that at least one object with the equivalent dominance coefficients is dominant to a higher ranked object based on at least one of the interactions listed in the asymmetric matrix of agnostic interactions and the assigned value in the dominance matrix;
if more than one object with the equivalent dominance coefficients is dominant to a higher ranked object, ranking these objects in order of highest dominance over a highest ranking object; and
if only one object with the equivalent dominance coefficients is dominant to a higher ranked object, then ranking the one object above remaining objects with equivalent dominance coefficients and ranking the remaining objects based on at least one of the interactions of the objects listed in the asymmetric matrix of agnostic interactions and on an assigned value in the dominance matrix between the remaining objects.

11. The method of claim 1, wherein the competing interacting objects are selected from a group of journals, journal articles, sport teams, sport team players, and coaches.

12. A dominance ranking system for dominance raking competing interacting objects, comprising:
at least one processor; and
at least one memory, communicatively coupled to the at least one processor and containing instructions that, when executed by the at least one processor, perform a method comprising:
selecting a group of interacting competing objects for ranking;
constructing an asymmetric matrix of agnostic interactions between the objects of the group;
constructing a dominance matrix by comparing all pairs of objects and assigning a value of at least one of 1.0, 0.5, and 0.0 to a corresponding cell in the dominance matrix;
calculating a number of circular triads with an equation as follows:
$$d = \frac{n ( n - 1 ) ( 2 n - 1 )}{12} - \frac{{Σ ( {S}_{i} )}^{2}}{2} ;$$
calculating a dominance coefficient for each of the objects, wherein the dominance coefficient is based on at least one of Landau's coefficient of hierarchy and Kendall's coefficient of consistency; and
ranking the objects based at least on the calculated dominance coefficient for each object.

13. The method of claim 12, wherein the step of calculating the Landau's coefficient, comprises:
determining how many objects are dominated by each object; and
utilizing an equation as follows:
$$h = \frac{12}{( {n}_{3} - n )} {\sum }_{i = 1}^{n} {[ {V}_{i} - ( n - 1 ) / 2 ]}^{2} .$$

14. The method of claim 12, wherein the step of calculating the Kendall's coefficient, comprises:
utilizing an equation if a total number of the objects in the group is odd as follows:
$$K = 1 - \frac{24 d}{( {n}_{3} - n )} ;$$
and
utilizing an equation if the total number of the objects in the group is even as follows:
$$K = 1 - \frac{24 d}{( {n}_{3} - 4 n )} .$$

15. The method of claim 14, further comprising:
calculating degrees of freedom;
calculating a chi-square test statistic;
calculating a p-value, wherein the total number of the objects is six or larger; and
determining if the objects have a linear hierarchy structure based on at least one of the chi-square test statistic, the degrees of free, and the p-value.

16. The method of claim 15, further comprising:
determining if the linear hierarchy structure is statistically relevant based on at least one of the chi-square test statistic, the degrees of free, and the p-value.

17. The method claim 12, where the step of constructing the asymmetric matrix of agnostic interactions comprises:
determining that the interactions per object vary; and
normalizing the interactions per object.

18. The method of claim 12, wherein the ranking step further comprises:
determining that at least some of the dominance coefficients are equivalent;
ranking the objects with the equivalent dominance coefficients based on the interactions listed in the asymmetric matrix of agnostic interactions and the assigned values in the dominance matrix between the objects with the equivalent dominance coefficients: and
determining that none of the objects with the equivalent dominance coefficients are dominant to a higher ranked object based on at least one of the interactions listed in the asymmetric matrix of agnostic interactions and the assigned value listed in the dominance matrix between the objects with the equivalent dominance coefficients before performing the step of ranking the objects with the equivalent dominance coefficients.

19. The method of claim 12, wherein the ranking step further comprises:
determining that at least some of the dominance coefficients are equivalent;
determining that at least one object with the equivalent dominance coefficients is dominant to a higher ranked object based on at least one of the interactions listed in the asymmetric matrix of agnostic interactions and the assigned value in the dominance matrix;
if more than one object with the equivalent dominance coefficients is dominant to a higher ranked object, ranking these objects in order of highest dominance over a highest ranking object; and
if only one object with the equivalent dominance coefficients is dominant to a higher ranked object, then ranking the one object above remaining objects with equivalent dominance coefficients and ranking the remaining objects based on at least one of the interactions of the objects listed in the asymmetric matrix of agnostic interactions and on an assigned value in the dominance matrix between the remaining objects.

20. The method of claim 12, wherein the competing interacting objects are selected from a group of journals, journal articles, sport teams, sport team players, and coaches.
